(19) United States
(12) Patent Application Publication
(10) Pub. No.: US 2026/0087855 A1
(43) Pub. Date: Mar. 26, 2026

(54) Multimodality face liveness detection approach

(71) Applicant: VIETTEL GROUP, Ha Noi City (VN)

(72) Inventors: THI HANH VU, Hai Phong City (VN); THI ANH NGUYEN, Ha Noi City (VN); MINH QUAN VU, Son La City (VN); VAN CUONG HOANG, Dong Hoi City (VN)

(73) Assignee: VIETTEL GROUP, Ha Noi City (VN)

(21) Appl. No.: 19/253,241

(22) Filed: Jun. 27, 2025

(30) Foreign Application Priority Data
Sep. 26, 2024 (VN) 1-2024-07226

(51) Int. Cl. G06V 40/40; G06V 10/30; G06V 10/62; G06V 10/72; G06V 10/764; G06V 10/77; G06V 10/776; G06V 10/80; G06V 10/82; G06V 40/16; G06V 40/70

(52) U.S. Cl. CPC G06V 40/45; G06V 10/30; G06V 10/62; G06V 10/72; G06V 10/764; G06V 10/7715; G06V 10/776; G06V 10/806; G06V 10/82; G06V 40/168; G06V 40/70

(57) ABSTRACT

A multimodality face liveness detection method to prevent biometric attacks on electronic identification authentication systems comprises 5 steps. Step 1: Training the backbone model for feature extraction, Step 2: Semi-automatic data preprocessing, Step 3: Data normalization and augmentation, Step 4: Building a deep learning model (BiMoTranS) for multimodal face liveness detection based on Transformer architecture with pre-training using the self-knowledge-distillation method, Step 5: Training the multimodal model using multi-modal data fusion techniques.

### TECHNICAL FIELD

The invention relates to a method for detecting multimodal face spoofing to prevent various types of biometric face spoofing attacks, including both physical and digital forms. Specifically, the method employs a deep learning model trained with two modalities—image and video data—and is designed to enhance the security of eKYC (Electronic Know Your Customer) systems against potential attackers.

### BACKGROUND

In the field of electronic user identification and personal security, facial recognition technology has become critical component of many applications. However, alongside this development, there has been a rapid rise in sophisticated and diverse forms of facial spoofing, which increases the risk of deceiving systems and compromising user security. Specifically, physical attack methods include the use of printed facial images, photos replayed from other devices such as phones or display screens, 3D masks made from silicone materials, and reconstructed facial images/videos using 3D scanners. Typical digital attack methods include artificial intelligence (AI) technologies to generate spoofed faces, such as Deepfake. Deepfake is a term derived from “deep learning” and “fake” referring to the use of AI to create highly realistic, counterfeit facial images and videos. This technology allows for the substitution of a person's face in an image or video with another person's face or generated one, producing forged videos that are nearly indistinguishable from authentic ones.

Currently, facial spoofing detection methods primarily rely on a single input modality like images (either a single image or a few frames), which leads to an increased risk of the systems being vulnerable to deception by advanced and sophisticated spoofing techniques, such as face generation technologies (Deepfake). The invention proposes a deep learning model designed to analyze and learn the concurrent characteristics and features of both images and videos from various types of spoofing. This enables the model to accurately distinguish between real and spoofed faces by detecting facial anomalies. The method not only enhances the flexibility of the model's inference process but also significantly improves the accuracy of each modality, as they can share additional cross-knowledge when co-trained.

The invention has significant potential for widespread application across domains such as security, banking, and law enforcement, enhancing information security and aiding in the prevention of fraudulent activities.

### BRIEF DESCRIPTION OF METHOD

The objective of the invention is to propose a multimodal face liveness detection method aimed at preventing biometric attacks on electronic identification authentication systems.

To achieve this objective, the method comprises the following steps:

Step 1: Training the backbone model for feature extraction; this step is carried out based on a spatial feature extraction model, which is trained on an unlabeled dataset using self-supervised learning techniques.

Step 2: Semi-automatic data preprocessing; this step uses the pre-trained backbone model from Step 1 to label or refine the data labels, filter out noisy and low-quality data, while retaining challenge data for the subsequent training process to enhance the model's knowledge integration and inference capability.

Step 3: Data normalization and augmentation; this step is performed using data normalization and transformation algorithms to increase the diversity and generalization of the input data for the next step.

Step 4: Building a deep learning model for multimodal face liveness detection called BiMoTranS: a two-modality model based on Transformer architecture with pre-training using self-knowledge distillation (BiMoTranS: Bi-Modality Transformer-based with Self-knowledge-distillation pretrained); the model is structured to comprise the following key components: (1) a spatial feature extraction block that encodes image data into feature vectors, (2) a temporal feature extraction block that encodes time information from video data into a sequence of feature vectors, (3) a pooling layer with a self-attention mechanism to extract and emphasize the most relevant spatial-temporal features, and (4) blocks for classifying multimodal input features (images and videos) into two class “real” or “fake”.

Step 5: Training the multimodal BiMoTranS model using multi-modal data fusion techniques; this step is carried out by simultaneously sampling image and video data to form input batches for training loops, with the backbone model initialized using the pre-trained weights from Step 1, along with typical model training techniques.

### BRIEF DESCRIPTION OF THE DRAWINGS

FIG. 1: is a diagram illustrating the overview of the multimodal face liveness detection method and the components of the BiMoTranS model: a two-modality model based on Transformer architecture with pre-training using self-knowledge distillation (Bi-Modality Transformer-based with Self-knowledge-distillation pretrained).

FIG. 2: is a diagram describing the semi-automatic data preprocessing process in Step 2, aimed at low-quality data, filtering challenge data, labeling or refining data labels.

### DETAILED DESCRIPTION

The invention described in detail below may refer to the accompanying figures, which are intended to illustrate the embodiments of the invention without limiting the scope of protection.

It should also be noted that in this disclosure, certain terms such as: “Transformer,” “Vision Transformer (ViT),” “InternImage,” “ConvNeXt,” “Cross-entropy,” “ViT-base,” “ViT-large,” “Squeezeformer,” “Recurrent Neural Network (RNN),” “Long-short Term Memory (LSTM),” “Label Smoothing Cross Entropy Loss,” “Adan Optimizer,” “Adam,” “AdaGrad,” “OneCycleLR,” “Deepfake” are proper nouns (names of algorithms, models, etc.)

The disclosure also refers to certain pre-existing formulas used in the field of information technology and artificial intelligence technology; however, the formulas are provided to illustrate their application in the solution described in this disclosure.

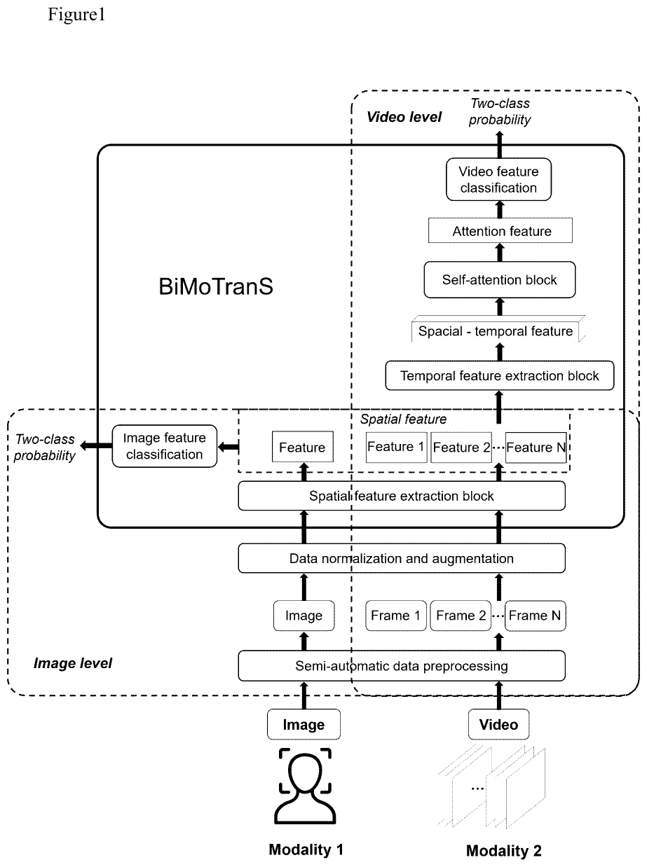

Referring to FIG. 1, which outlines the components of the multimodal face liveness detection method.

Specifically, the method described in the disclosure comprises the following steps:
Step 1: Training the backbone model for feature extraction;
In this step, the dataset used to train the feature extraction model is unlabeled. The training method employs self-supervised learning technique. The objective of this step is to generate initial weights for the spatial feature extraction model, which will be used in the subsequent steps. The feature extraction models proposed in this step include Vision Transformer (ViT), InternImage, and ConvNeXt.

The hyperparameters used for training the backbone feature extraction model: the loss function is Cross-entropy, optimized by the Adam optimization algorithm, with an initial learning rate set to 5×10⁻⁴, and the momentum initialized to 0.996, used for the Exponential Moving Average (EMA). The training performance is evaluated through the value of the loss function, with the goal of minimizing the loss to improve training results. These hyperparameters are initialized and defined through multiple experiments to achieve the highest performance of the model across various datasets.

Step 2: Semi-automatic data preprocessing;

This step performs the cleaning and fine-tuning of data labels in a semi-automatic manner. Specifically, low-quality data exhibits characteristics such as being too blurry, too dark, too bright, too noisy, or containing multiple faces in a single frame, among others. In terms of quantity, it ensures a balanced number of data points per label to avoid bias during model training.

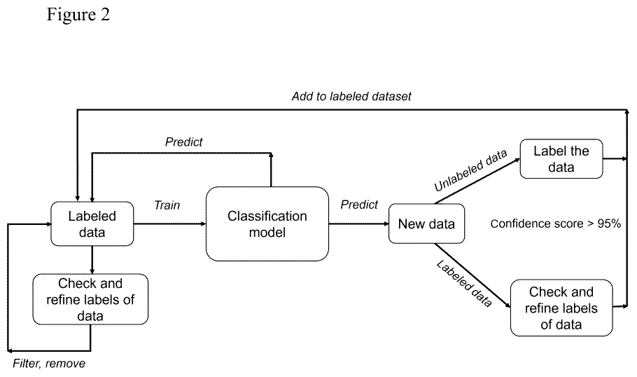

The semi-automatic data preprocessing method is described with reference to FIG. 2. The dataset includes both real and spoofed data, focusing on two types: physical attacks and digital attacks. The physical attack type refers to attackers using 2D printed facial images, 3D printed facial images (3D modeling from 2D printed masks), face images replayed on electronic devices (phones, tablets, laptops, desktop computers, televisions, etc.), faces reconstructed using 3D face scanning technology, and particularly silicone masks. This type of digital attack involves the use of artificial intelligence tools to generate spoofed face data, typically falling into two main categories: completely fabricated faces real faces that have been manipulated by swapping specific features onto another individual's face.

The semi-automatic data preprocessing method has three main tasks: fine-tuning data labels, removing noisy/low-quality data, and filtering challenge data from supplementary datasets.

The semi-automatic data preprocessing method starts with a small dataset consisting of a few thousand data points which are manually labeled by experts to ensure high accuracy. A label classification model is created by combining the pretrained backbone feature extraction model from Step 1 with a binary real-fake classification layer and is trained on this labeled dataset to optimize the weights. Next, the label classification model is used to predict on two datasets:
First, the model is retrained on the labeled dataset. For the data points that were included in the training set but still misclassified by the model, it is necessary to review and correct these labels (if the misclassification is due to labeling errors) or to remove outlier data that may hinder the model from learning the relevant features.
Next, the model is applied to the remaining (untrained) data, which may consist of unlabeled data or labeled data that has not yet been selected or verified for accuracy. For:
   Unlabeled data: Select data points for which the model demonstrates high confidence in its predictions (confidence score >95%), assign labels based on those predictions, and add them to the training dataset.
   Labeled data: Identify data points where the model's predictions were incorrect, review and relabel them (if the original labels were inaccurate), and then include the corrected samples in the training dataset.

This process is iteratively repeated until a sufficiently large and accurately labeled dataset is achieved (typically comprising several hundred thousand samples). This semi-automatic data preprocessing approach significantly reduces the time required for manual labeling. Notably, once the dataset reaches an adequate size, subsequent efforts can focus on more challenging data without the need to retrain on the entire collected dataset, thus reducing training time and computational resource consumption.

Step 3: Data normalization and augmentation;

The data that has been preprocessed in Step 2 is further normalized and augmented.

The data consists of two modalities: image and video data. Video data is segmented into a sequence of consecutive frames, from which representative frame samples are selected at defined time intervals. This approach aims to reduce redundancy among similar frames while optimizing processing time and computational resource usage. The frames are sampled evenly across the length of the video, with the number of samples per video being the same, typically set to 16 or 32 based on experimental results targeting high accuracy while optimizing hardware efficiency.

Next, image modality data (including individual images and frames sampled from video) is normalized to the same size format [C, H, W], where C represents the number of channels, H is the height, and W is the width. The size is chosen depending on the feature extraction model in the backend and the computational capabilities of the resources. Typical sizes may include [3, 224, 224], [3, 448, 448], etc. Video modality data will have a normalized size of [n_{frame}, C, H, W], where n_{frame} denotes the number of sampled frames per video.

Subsequently, data transformation methods are applied to augment the data by creating variations from the original dataset. These data augmentation methods enhance data diversity, improve the model's generalization ability, and reduce the risk of overfitting during training. The invention proposes a label-dependent data enrichment approach. Since the features and identifiers of real faces and various types of spoofs are different, the data augmentation methods must ensure that these characteristics of each class are preserved and not altered. Specifically:
For data labeled as spoofed, geometric and photometric transformations are applied so that the data can cover more realistic cases of forgeries. Geometric transformations alter the shape and size of the image by rotating the image, translating the image, resizing the image, or flipping the image along the horizontal or vertical axis. Photometric transformations modify pixel intensity by changing the brightness, contrast, color on the RGB channels, or adding noise to simulate images taken under real-world conditions. These transformation methods are applied randomly on the dataset with a probability of 50% or customized per label for each transformation.
For data labeled as real, the data enrichment method ensures that the original data properties are not affected. In this case, the original data refers to the raw data directly captured by the device's camera without modification. Therefore, the only geometric transformation applied is flipping the image along the vertical axis, and this is done randomly on the dataset with a probability of 50%.

Step 4: Constructing a deep learning model for multimodal face anti spoofing, named BiMoTranS: Bi-Modality Transformer-based with Self-knowledge-distillation pretrained.

In this step, the invention proposes a novel deep learning model named BiMoTranS. This model is constructed from spatial and temporal feature extraction blocks and a pooling layer with a self-attention mechanism, allowing for high adaptability and the processing of multimodal inputs.

Specifically, the BiMoTranS model is described in FIG. 1. First, the two modalities of image and video data are normalized into a four-dimensional matrix to serve as input to the spatial feature extraction block. The two modalities are combined into a batch with the following size [B_{image}+B_{video}×n_{frame}, C, H, W], where α_{image} is the batch size of the image data, and B_{video} is the batch size of the video data. Spatial features can represent information such as edges, contours, object corners, texture of objects (smooth, rough, striped, etc.), pixel color, pixel brightness, basic shape of objects, object position, as well as high-level features expressing the meaning of the image or actions occurring within the image. Proposed models for the spatial feature extraction block include Vision Transformer (ViT), InternImage, and ConvNeXt. The output of this block is encoded data, represented as a smaller feature vector size compared to the original data. The size of the feature vector depends on the output size of each type of model. Larger models that can learn more features will have larger feature vectors. For example, the output of the ViT-base model has a size of 768, while the output of the ViT-large model has a size of 1024. The weights in the spatial feature extraction block are initialized with pretrained weights from Step 1, obtained via self-supervised learning method.

The spatial feature vector representing the image is directly fed into the image modality classification branch, which consists of classification of single images and frames sampled from videos. That is, the model will treat each frame of the video as a data point, with each frame's label being assigned according to the video label. This enables the spatial feature extraction model to learn meaningful representations from both individual image data and video frame data. The image modality classifier is designed as a linear function, with the output size being [B_{image}+B_{video}×n_{frame}, 2], where the second dimension corresponds to the number of target classes, with values representing class probabilities. Accordingly, the image is assigned to the class with the highest predicted probability.

The spatial feature vector representing the video is processed and stacked into a matrix with size [B_{video}, n_{frame}, dₛₚₐₜᵢₐₗ], where dₛₚₐₜᵢₐₗ is the dimensionality of the spatial feature vector. The spatial feature extraction block is responsible for extracting features from each frame of the video. In addition to spatial information, video data also has temporal features, which include relationships between objects withinframes according to the temporal sequence, representing the changes of the video content over time. Proposed models for the temporal feature extraction block include Squeezeformer, Recurrent Neural Network (RNN), Long Short-Term Memory (LSTM), or Transformer, all of which are effective sequential processing network architectures. After passing through the temporal feature extraction block, the features of the video are represented as a sequence with the size of [B_{video}, N_{sequence}, dₜₑₘₚₒᵣₐₗ], where N_{sequence} and dₜₑₘₚₒᵣₐₗ are the number of output sequences and the dimension of the temporal feature vector, depending on the output of different temporal feature extraction models.

Next, to focus on relevant features, a pooling layer with a self-attention mechanism is added after the above spatial-temporal feature extraction blocks. This pooling layer is essentially a trainable weight layer that learns weights for each sequence of the feature vector. Finally, the features are aggregated along the N_{sequence} dimension to obtain the final feature vector representation for the video, with the size of [B_{video}, dₜₑₘₚₒᵣₐₗ].

The focused feature vector of the video is passed through the video modality classification branch to compute the probability distribution for each class. This video modality classification branch has an architecture similar to the image modality classification branch described earlier.

Step 5: Training the BiMoTranS multimodal model using the simultaneous multimodal data fusion technique;

In this step, the invention proposes a method for training the BiMoTranS model, specifically leveraging a simultaneous multimodal data fusion technique during the training process.

To perform this process, the image and video modalities are simultaneously sampled to form a batch input for one training loop of the model. The sampling method is as follows: the image and video data are divided into an equal number of batches, and in each training loop, one image batch is trained alongside one video batch. This ensures that both the image classification task and the video classification task are optimized in each loop. The training data has the following size: [B_{image}+B_{video}×n_{frame}, C, H, W], where B_{image} is the batch size for image data and B_{video} is the batch size for video data. The values of B_{image} and B_{video} are chosen depending on the dataset size and available training resources.

The BiMoTranS model is trained using the Label Smoothing Cross Entropy Loss function. The loss value (l) is computed and accumulated over the three outputs: l=l_{image}+l_{frame}+l_{video}. This loss value is used to calculate the gradients for each parameter, and then those parameters are updated according to a specific optimization method.

During training, the model's weights are updated using the Exponential Moving Average (EMA) technique, which computes the exponentially weighted moving average of the weights during the training process. EMA is utilized to smooth the weights, stabilize the training process and improve performance by reducing noise and fluctuations, based on updates from the previous weights. Specifically, the EMA of the weight at the loop of the training process, denoted as EMAₖ is computed using the following formula (This is a pre-existing formula, included in the disclosure to clarify the issues discussed in this disclosure):

$${EMA}_{k} = \{ \begin{matrix}{θ}_{1} & if k = 1 \\ β \times {EMA}_{k - 1} + ( 1 - β ) \times {θ}_{k} & if k \neq 1\end{matrix}$$

wherein, θₜ represents the model's weight at the k iteration, and β∈[0, 1] is referred to as the decay value or smoothing factor. When β∈[0, 1] approaches 1, the model's weight update according to EMA predominantly depends on the previous weight, i.e., it is less sensitive to changes in the current parameters. Conversely, when β∈[0, 1] nears 0, the model's weight update according to EMA responds more quickly to weight changes. Through the experimental evaluations within the scope of this invention, it has been determined that selecting β∈[0, 1] within the range of 0.9 to 0.999 results in stable training performance.

The weight optimization technique used is the Adan Optimizer, a combination of two optimization techniques: Adam and AdaGrad. Adan inherits the learning rate adaptation mechanism of Adam, which helps the model converge faster. Additionally, it utilizes the squared gradient accumulation mechanism of AdaGrad, which helps stabilize the model and prevents issues such as vanishing gradient or exploding gradient.

The learning rate adjustment strategy employed during the optimization process is OneCycleLR, which dynamically adjusts the learning rate throughout the training process instead of keeping it fixed. During training, OneCycleLR adjusts the learning rate in a cycle comprising stages of increasing, maintaining, and decreasing the rate, depending on parameters such as the maximum learning rate value, the total number of training epochs, and the number of training steps.

Although the aforementioned descriptions contain many specific details, they are not to be construed as limiting the implementation options of the invention but are intended to illustrate some of the preferred implementations.

1. A multimodality face liveness detection method includes the following steps:
step 1: training a backbone model for feature extraction, based on a spatial feature extraction model, which is trained on an unlabeled dataset using self-supervised learning techniques;
step 2: semi-automatic data preprocessing; using the pre-trained backbone model in Step 1 to label and refine data labels, filter out noisy and low-quality data, while retaining challenging data to enhance the training process, helping to increase knowledge synthesis and reasoning capabilities of the model;
step 3: data normalization and augmentation; applying normalization and transformation algorithms to enhance the diversity and generalization of input data for a next phase of model training;
step 4: building a deep learning model for multimodal face liveness detection called BiMoTranS: a two-modality model based on Transformer architecture with pre-training using the self-knowledge-distillation method (BiMoTranS: Bi-Modality Transformer-based with Self-knowledge-distillation pretrained), the model includes the following components: (1) a spatial feature extraction block that encodes image data into feature vectors, (2) a temporal feature extraction block that encodes temporal information from video data into a sequence of feature vectors, (3) a pooling layer with a self-attention mechanism to select most important non-temporal features, (4) multimodal feature classification blocks for input features from both image and video;
step 5: training the BiMoTranS multimodal model using multimodal data fusion techniques; by simultaneously sampling data from both image and video modalities to create input batches for training loops, the backbone model is initialized using the pre-trained weights from Step 1, along with various typical model training techniques.

2. The multimodality face liveness detection method according to claim 1, where:
in step 1, the backbone model for feature extraction is trained on an unlabeled dataset and utilizing self-supervised learning techniques, the hyperparameters used for training the backbone feature extraction model include: a cross-entropy loss function, an Adam optimization algorithm, an initial learning rate initialized at 5×10⁻⁴, and a momentum coefficient initialized at 0.996 applied to an exponential moving average (EMA) function.

3. The multimodality face liveness detection method for face liveness detection through multimodal approaches as described in claim 1, where:
the backbone models for spatial feature extraction include Vision Transformer (ViT), InternImage, and ConvNeXt.

4. The multimodality face liveness detection method as described in claim 1, where:
in step 2, starting the semi-automatic data preprocessing method with a small dataset containing several thousand samples per label, which are manually labeled to ensure accuracy, creating a label classification model by combining the pre-trained backbone feature extraction model in Step 1 with a binary classification layers, the model is then trained on this labeled dataset to optimize the weights, after training, using the label classification model to predict on two datasets:
first, the model predicts on the labeled dataset, for those data points that the model misclassifies, reviewing and correcting labels (if the label was incorrect) or removing outlier data, as these may hinder the model from learning the relevant features;
next, the model predicts on the remaining (untrained) data, which may be either unlabeled data or labeled data that has not yet been selected or validated for accuracy, then:
unlabeled data: selecting samples with high confidence score (>95%) resulted from model, labeling samples as model predicted and adding these samples to the training dataset;
labeled data: selecting samples where the model results incorrect predictions, verifying the labels (if the true label was incorrect), and reassigning correct labels, then adding these samples to the training dataset;
repeating the process until the labeled dataset reaches a sufficiently large size of around several hundred thousand samples, afterward, shifting focus to exploring challenging samples without need to train on an entire collected dataset.

5. The multimodality face liveness detection method as described in claim 1, where:
in Step 3, the video data is split into a sequence of consecutive frames, frames are sampled evenly over a length of the video, with a number of samples being the same across all videos, a number of samples selected from each video is either 16 or 32, image modality data (including individual images and frames sampled from the video) is normalized to a same size, represented as [C, H, W], where C presents a number of channels, H presents height, and W presents width, the size is chosen depending on the feature extraction model used and computational resources available, wherein typical sizes may include [3,224,224], [3,448,448], etc, video modality data will have a standardized size of [n_{frames}, C, H, W], where n_{frames} represents a number of frames sampled;
a data augmentation method is proposed:
for data labeled as true negative, applying geometric and photometric transformations to enhance the diversity of spoofing scenarios represented in the dataset, wherein the transformations are performed randomly to the dataset with a probability of 50%, or customized per label for each method;
for data labeled as true postive, the only geometric transformation applied is vertical image flipping, which is randomly performed to the dataset with a probability of 50%.

6. The multimodality face liveness detection method as described in claim 1, where:
in Step 4, a two-modality model (BiMoTranS model) is built based on Transformer architecture with pre-training using the self-knowledge-distillation method (BiMoTranS: Bi-Modality Transformer-based with Self-knowledge-distillation pretrained), the model consists of spatial and temporal feature extraction blocks, as well as a pooling layer with a self-attention mechanism, which enables high adaptability and the ability to process multimodal inputs.

7. The multimodality face liveness detection method as described in claim 1, where:
data from the two modalities: image and video, are normalized into a four-dimensional matrix as input for the spatial feature extraction block, the two modalities are combined into a batch with size: [B_{images}+B_{videos}×n_{frames}, C, H, W], where: B_{images} represents a batch size of image data, and B_{videos} represents a batch size of video data, the models for the spatial feature extraction block include Vision Transformer (ViT), InternImage, and ConvNeXt, the model in this spatial feature extraction block uses the pre-trained weight initialization from Step 1 with a self-supervised learning method.

8. The multimodality face liveness detection method as described in claim 1, where:
the spatial feature vector representing the image is passed directly into an image modality classification branch, which includes classifying individual images and frames sampled per video, a linear function used as the classifier for image modality, with an output size of [(B_{images}+B_{videos}n_{frame}), 2], where the second dimension corresponds to the number of target classes, with values representing class probabilities: live or spoof, predicting that the image belongs to the class with the higher probability.

9. The multimodality face liveness detection method as described in claim 1, where:
the spatial feature vector representing the video is processed and stacked into a matrix with the size of [B_{videos}, n_{frames}, dₛₚₐₜᵢₐₗ], where dₛₚₐₜᵢₐₗ presents the spatial's dimention feature vector, in addition to spatial information, video data also contains temporal features, after passing through the temporal feature extraction block, the features of the videos are represented as a sequence with a size of [B_{video}, N_{sequences}, dₛₚₐₜᵢₐₗ], where N_{sequences} and dₛₚₐₜᵢₐₗ represent a number of output sequences and the dimensionality of the temporal feature vector, respectively, depending on the output of the different temporal feature extraction models.

10. The multimodality face liveness detection method as described in claim 1, where:
the proposed models for the temporal feature extraction block include Squeezeformer, Recurrent Neural Network (RNN), Long Short-Term Memory (LSTM), or Transformer.

11. The multimodality face liveness detection method as described in claim 1, where:
a pooling layer with a self-attention mechanism is added after the spatio-temporal feature extraction blocks, the pooling layer being a weighted, trainable layer that learns weights for each sequence of the feature vector, afterward, performing a feature accumulation along the N_{sequence} dimension to obtain a final feature vector representation for the video, with a size of [B_{video}, d_{sequence}].

12. The multimodality face liveness detection method as described in claim 1, where:
the final feature vector (the output of the self-attention pooling layer) of the video is passed through the video modality classifier branch to compute the probability distribution for each class, this classifier is designed as a linear function, with the output representing the probability that the data belongs to either live or spoof, then predicting the image to belong to the class with the higher probability.

13. The multimodality face liveness detection method as described in claim 1, where:
in step 5, using the technique of simultaneous multimodal data fusion for training the BiMoTransS model;
simultaneously sampling the images and videos data from two modalities to create a batch of input for one training loop of the model, wherein sampling process is as follows: the image and video data are divided into an equal number of batches, and in one training loop, an image data batch is trained simultaneously with a video data batch, where the training data has the following size: [B_{image}+B_{video}×n_{frames}, C, H, W], where B_{image} is the batch size for image data, B_{video} and is the batch size for video data, the values of B_{image} and B_{video} are chosen based on the size of the dataset and the available training resources.

14. The multimodality face liveness detection method as described in claim 1, where:
the BiMoTranS model is trained with a loss function label smoothing cross entropy loss, a loss value (l) is computed and accumulated over three outputs: l=l_{images}+l_{frames}+l_{videos}, this loss value is then used to calculate a gradient for each parameter and update the parameter values according to an optimization method.

15. The multimodality face liveness detection method as described in claim 1, where:
during the training process, the model updates its weights using Exponential Moving Average (EMA) technique which computes the exponential moving average of the weights during training, EMA is used to smooth the weights based on a smoothing coefficient; a value is chosen in a range from 0.9 to 0.999 based on experimental results.

16. The multimodality face liveness detection method as described in claim 1, where:
the weight optimization technique used is Adan optimizer, which is a combination of two optimization techniques: Adam and Adagrad.

17. The multimodality face liveness detection method as described in claim 1, where:
a learning rate update strategy employs during the weight optimization process is OneCycleLR, wherein the learning rate of the optimizer is adjusted according to a specific learning cycle rather than being fixed.
